(19) United States
(12) Patent Application Publication
(10) Pub. No.: US 2018/0072623 A1
(43) Pub. Date: Mar. 15, 2018

(54) RETARDING MIXTURE FOR ALKALI-ACTIVATED BINDING AGENTS

(71) Applicant: HEIDELBERGCEMENT AG, HEIDELBERG (DE)

(72) Inventors: PETER BLAUM, BODENHEIM (DE); FRANK BULLERJAHN, LEIMEN (DE); MACIE J ZAJAC, HEIDELBERG (DE)

(21) Appl. No.: 15/552,928

(22) PCT Filed: Mar. 14, 2016
(86) PCT No.: PCT/EP2016/000452

§ 371 Date: Aug. 23, 2017

(30) Foreign Application Priority Data
Mar. 17, 2015 (EP) 15000784.7

(51) Int. Cl. C04B 22/10; C04B 24/06; C04B 28/08; C04B 40/00

(52) U.S. Cl. CPC C04B 22/106; C04B 24/06; C04B 2103/20; C04B 40/0039; C04B 28/08

(57) ABSTRACT

The invention relates to a retarding mixture comprising sodium gluconate and alkali hydrogen carbonate, an alkali-activated binding agent containing sodium gluconate and alkali hydrogen carbonate and a method for adjusting the strength development, wherein sodium gluconate and alkali hydrogen carbonate are added to an alkali-activated binding agent.

The present invention relates to retarding mixtures which delay the setting and/or hardening of alkali-activated inorganic binding agents, in particular geopolymers.

Geopolymer designates inorganic binding agents that, analogously to classic Portland cement, can be mixed to a pourable paste and then harden to solid structures. In contrast to Portland cement based systems, the hardening in classic geopolymers that form zeolite-like structures takes place by means of a reaction of a silicate with an aluminate under strongly alkaline conditions. Typically, these conditions can be provided by a combination of an alkali metal hydroxide solution and an alkali metal silicate solution, wherein an aqueous binding agent system emerges. Alternatively, a dry binding agent system can be produced by a solid activator being used, for example a solid alkali metal silicate. The result of the reaction of the geopolymer is an amorphous, three-dimensional network of silicon and aluminium atoms that are crosslinked by oxygen atoms to a polymer structure.

To produce classic geopolymers that form zeolite-like structures, raw materials are used which provide silicates and aluminates in suitable quantities. In principle, mineral raw materials, e.g. metakaolin, or synthetic materials such as industrial by-products, e.g. silicon-rich fly ash, can be used. From economical and ecological points of view, the use of industrial by-products is preferred to the use of mineral raw materials. In the more recent past, the spectrum of the raw materials/industrial by-products used for the production of the kind of binding agent previously mentioned has gradually expanded. Along with pozzolanically active, silicon-rich fly ash, latent hydraulic and/or pozzolanically active, calcium-rich fly ash and granulated blast furnace slag/slag, in particular, are thus used.

The reactivity of the raw materials significantly influences the effectiveness of the geopolymer binding agent produced and is determined by the following properties of the raw materials:

Proportion of the reactive glass phase by volume

Proportion of the reactive crystalline phases by volume

Chemical composition of the glass phase

Free lime content

Carbon content

Size of the reactive surfaces.

A high proportion of the glass phase by volume is advantageous for the reactivity of the binding agent since the glass phase has high solubility. In addition, the reactivity is determined by the chemical composition: the higher the CaO content, the higher the reactivity. However, materials with a high free lime content should be avoided since free lime can cause flash setting. Carbon compounds in the form of unburnt coal particles increase the required amount of an activator and the water demand because of their large internal surface, which worsens the performance of the binding agent and increases the costs. The reactive surface is a further important influencing variable, the higher the reactive surface, the more soluble the raw material. Thus, the use of ground raw materials containing aluminosilicates is advantageous, which has a greater impact with fly ash than with granulated blast furnace slag. Typical values for said properties with common raw materials are compiled in the following table 1:

TABLE 1

| | | | Granulated |
|---|---|---|---|
| Property of the raw | Silicon-rich | Calcium-rich | blast furnace |
| material | FA | FA | slag |
| Proportion of glass phase | 60-80 | 40-60 | 90-100 |
| [wt %] | | | |
| CaO content [wt %] | 0-10 | 12-40 | 35-45 |
| CaO content without free | 0-10 | 10-30 | 35-45 |
| lime [wt %] | | | |
| Free lime [wt %] | 0 | 2-10 | 0 |
| Unburned coal particles | 0-5 | 0-8 | 0 |
| [wt %] | | | |

| | |
|---|---|
| Surface [cm²/g] | The size of the reactive surface depends on |
| | the grinding fineness chosen. A fineness |
| | of about 4000 cm²/g is recommended. |

The activator should provide a high pH value in order to be able to dissolve the raw materials used of a glassy crystalline nature (e.g. fly ash, granulated blast furnace slag). In doing so, the chemical bonds in the present aluminosilicate, calcium silicate, calcium aluminosilicate, calcium aluminate, calcium ferrite, and calcium aluminoferrite compounds are broken up, and the monomer and polymer fragments released are supplied to the pore solution. Furthermore, the activator supplies silicon and aluminium oxide compounds, which facilitate the formation of the geopolymer network. Different substances are suitable as the activator for geopolymers:

Alkaline/alkaline earth silicates, e.g. sodium or potassium silicate, sodium metasilicate, both anhydrous and pentahydrate

Alkaline/alkaline earth hydroxides, e.g. sodium hydroxide, calcium hydroxide, potassium hydroxide

Alkaline/alkaline earth carbonates, e.g. sodium carbonate

Alkaline/alkaline earth sulphates, e.g. sodium sulphate, potassium sulphate

Combinations of the previously mentioned substances

Portland cement (clinker) in combinations with at least one of the previously mentioned substances.

The alkaline activator can be added as a liquid or solid component. When adding in a solid state, the activator is preferably ground together with the latent hydraulic and/or pozzolanically active binding agent components in order to increase the reactivity. The co-grinding can be initiated during the ongoing grinding process of the previously mentioned latent hydraulic and/or pozzolanically active binding agent components. If these are already present in a ground or sufficiently fine form, an additional grinding step can be carried out in order to be able to guarantee an adequately homogeneous distribution of the activator, respective equal wetting of the reactive surfaces of the raw material. Liquid activator components are prone to carbonating, thus they have to be stored in a sealed manner. Depending on the activator components, different pH values are obtained, the following table 2 gives an overview.

TABLE 2

| | | | | pH of a 1% |
|---|---|---|---|---|
| | SiO₂ | Na₂O | SiO₂/Na₂O | solution at |
| Activator components | [wt %] | [wt %] | [i.a.] | 20° C. |
| Sodium silicate solution | 26-33 | 8-17 | 1.6-3.2 | 11-13 |
| (Water glass) (l) | | | | |
| Sodium metasilicate | 28.5 | 28.7 | 1.0 | 12.5 |
| pentahydrate (s) | | | | |
| Sodium metasilicate | 47.0 | 51.0 | 0.9 | 12.6 |
| (anhydrous) (s) | | | | |
| Sodium hydroxide (s) | — | 76.0 | — | 13.1 |
| Sodium carbonate (s) | — | 58.0 | — | 11.4 |

The hardening of geopolymers can be divided into three phases. In the first phase, silicates, aluminates and ferrites are released by breaking up the chemical bonds from the present glassy crystalline binding agent components/raw materials. This is initiated by hydroxide ions from the activator. Thus, monomolecular and condensed fragments are introduced into the pore solution. Depending on the chemical structure of the geopolymer, the release requires very strong alkalis, or weaker alkaline substances suffice. Above all, strong activators are necessary for geopolymers that consist predominantly of aluminosilicate, i.e. network forming aluminium and silicon oxides, since many covalent bonds are present. If the aluminosilicate structures are modified by a substantial content of foreign ions such as Ca²⁺, Mg²⁺, Na⁺, K⁺ in the glass phase, many ionic bonds are present that can also be broken by weaker activators. Silicon-rich fly ash consequently requires strong activators, such as alkaline hydroxides and alkaline silicates; weaker activators such as carbonates are often sufficient for lime-rich fly ash and granulated slag.

In the second phase, transportation and coagulation take place which aid the formation of a precursor gel.

In the third phase, the condensation takes place in which the solid three-dimensional network of aluminosilicates is formed. Here, mono and polysilicate ions from the activator can aid the reorganisation of the aluminosilicate fragments from the geopolymer to solid structures with a higher degree of polymerisation.

Whenever relevant contents of CaO are present, such as with granulated blast furnace slag and lime-rich fly ash for example, hydration processes are also initiated analogously to Portland cement. Along with the geopolymer gel, calcium silicate hydrates (C—S—H), calcium aluminate silicate hydrates (C-A-S—H), metal metal hydroxide (e.g. representatives of the hydrotalcite group) and Ca metal hydroxides (e.g. representatives of calcium aluminate hydrates) are formed. The hydration processes that consume water increase the pH value of the pore solution and thus the dissolution speed of the latent hydraulically and/or pozzlonaically active binding agent components/raw materials. Thus, the presence of calcium contributes to the mechanical strength of the hardened binding agent system, not only by forming C—S—H and C-A-S—H, but also by accelerating the geopolymer hardening. The reaction of the geopolymers can also be accelerated by heating to up to 90° C.

The composition of the geopolymer binding agent has to take different parameters into account and can thus be complicated. The most important parameters are the CaO content, the content of activator and the SiO₂/Na₂O ratio in the activator. Furthermore, the water/binding agent value and the hardening temperature exert an important influence.

Silicon-rich fly ashes with a low content of CaO, typically <10 wt %, result in classic geopolymer binding agents that substantially only harden by forming aluminosilicate networks (zeolites). Here, strongly alkaline activators are used. When the CaO content increases to >10%, such as when using latent hydraulically active calcium-rich fly ash or granulated blast furnace slag, for example, during the hardening, the formation of C—S—H, for example, is added to the polymerisation process.

For geopolymers with a low CaO content of <10%, as a rule 12-17% activator, an SiO₂/Na₂O ratio in the activator of 0.75 to 1.0 and a water-binding agent value of about 0.35 are suitable.

The strength that is able to be obtained increases in these binding agents with an increasing CaO content. The CaO content, however, also strongly influences the open time of the binding agent. With an increasing CaO content, the open time reduces so much that processing is no longer possible. Thus, for such geopolymer binding agents, retarding admixtures are necessary.

In geopolymer binding agents with a CaO content from 10 wt %, as they are obtained, for example, with granulated blast furnace slag as the raw material, the activator has to be individually adjusted to the specific system. Usually, geopolymers with CaO contents in the lower range of <10% require somewhat larger amounts of activator; with a CaO content of >10 wt %, optimal strengths mostly arise having lower contents of activator.

To check the optimal composition, methods adapted from EN 196-1 can be used, wherein 450 g binding agent, 1350 g sand and a water binding agent value (W/B) of 0.35 to 0.4 are used. In a useful composition, such mortars should produce a compressive strength of at least 10 MPa after 2 days of hardening at 20° C. It turned out that geopolymer binding agents with a low to medium CaO content react very sensitively to variations of W/B; an increase of W/B by 0.05 can lead to halving the strength. The strength after 28 days can be up to 60 MPa, but depends greatly on the latent hydraulically and/or pozzolanically active binding agent components used and the total composition.

One problem is that high strength is often accompanied by a poor processability in terms of a very short open time. The two properties can be influenced by the amount and type of activator; the requirements, however, are contrary. Mostly an increase of W/B does not result in longer processability, contrary to in Portland cement systems. Thus, a retarding admixture is necessary.

Whereas, in Portland cement (OPC), a multitude of admixtures and, among them also, retarders, are known and have proved successful, with geopolymers, the prior art in terms of admixtures is limited and, in some cases, contradictory. Authors are in agreement that an effect in geopolymers cannot be inferred from the effect in OPC.

Here, admixtures means those substances that are added to specifically change/adjust properties of the binding agent while processing or of the hardened system. Examples for admixtures include concrete admixtures according to DIN EN 934 and those with technical approval, for example: concrete liquefiers, plasticizers, air-entraining agents, sealants, retarders, setting accelerators, hardening accelerators, stabilisers etc. Activators are not included, although these are used as admixtures in OPC based systems; in the geopolymers, the activators are a component of the binding agent. Furthermore, the additives used in concrete in order to specifically improve or obtain properties such as rock flours (filler), pigments, fibres etc., have to be distinguished from the admixtures.

The use of admixtures in the alkali-activated binding agent systems according to the invention has to take several specific features of these systems into account. Firstly, even the small amount of water introduced with the admixture has to be taken into consideration for the W/B since the binding agent is very sensitive to this. The possible content of carbon compounds in the form of unburnt coal particles, in particular in systems made of fly ash, can drastically influence the dosing of the admixture, since admixtures are typically organic substances that are preferably connected on the inner surfaces of the non-reactive coal particles that are dominant in terms of area. Furthermore, it must be ensured that an impact is not based on effects such as entrapped air. Many organic admixtures also work as air-entraining agents and can simulate a liquefying effect, for example, by introducing air bubbles. The very high pH value of the binding agents is particularly challenging, as a result of which many admixtures that can be used in OPC are made ineffective, e.g. by being decomposed.

According to WO 2008/017413 A1 and EP 2 093 200 A1, boric compounds, lignosulphates, sodium gluconate, sodium glucoheptonate, tartaric acid and phosphorous compounds are deemed effective as retarders in geopolymer cement. However, these two applications are concerned with a very specific use, namely mixtures for oil drilling uses capable of pumping in which the requirements for processability, strength development and final strength deviate greatly from those in building construction and in other sectors. A particularly crucial difference is the increased temperature during use and hardening. In the examples, boric compounds, lignosulphate and phosphorous compounds are tested, but only for boric compounds the strength is also determined. This decreases in comparison to the systems that are not delayed. Both documents also propose adding accelerators and mention alkali hydroxides as usable substances, with WO 2008/017413 additionally mentioning alkali carbonates. In addition, the composition of the geopolymer and the activators should be adjusted. A general usefulness of said the mentioned substances for retarding geopolymers cannot be deduced from these documents.

In U.S. Pat. No. 4,306,912, a binder is described in which a mixture made of slag, synthetic or natural pozzolans, a liquefier such as sulphonated polyelectrolytes and sodium carbonate or sodium hydroxide should partially or completely replace Portland cement. In this publication, it is mentioned that U.S. Pat. No. 3,960,582, U.S. Pat. No. 3,959,004 and U.S. Pat. No. 4,032,353 describe sodium hydrogen carbonate combined with a liquefier for producing easily flowing concretes. According to the tests in U.S. Pat. No. 4,306,912, hydrogen carbonates, however, are hardly or not at all effective in the binding agents tested. One explanation for this could be that, in U.S. Pat. No. 3,960,582, U.S. Pat. No. 3,959,004 and U.S. Pat. No. 4,032,353, only Portland cements and pozzolan cements were tested and the effectiveness in alkali-activated binding agents deviates from that in the binding agents containing predominantly Portland cement.

In scientific investigations, a series of potential retarders were checked. Puertas F. et al. in Provis J. L. et al. “Alkali Activated Materials, State of the Art Report RILEM TC 224-AAM”, Springer Verlag give a summary with key points in chapter 6.3, p. 147-149. There, it is reported that phosphoric acids and (hydrogen) phosphates, boric compounds and NaCl, among others, were investigated; however, the effectiveness varied. There were also already suggestions for specific mixtures.

In terms of liquefiers and plasticisers, which can also improve processability, the results of the tests are just as inconsistent, see Puertas F. et al in chapter 6.4, p. 150-152. The effectiveness of lignosulphates seems to be confirmed, while other substances do not have a reliable effect.

Thus, there is an ongoing need for an additive or method for adjusting the processability which is effective in alkali-activated binding agents and does not substantially impair the strength development and the achievable strengths.

Surprisingly, it has now been found that a combination of sodium gluconate and alkali hydrogen carbonate reliably increases the open time for alkali-activated binding agents without relevant losses in strength or a substantial impairment of the strength development occurring.

The above object is thus solved by a retarding mixture comprising sodium gluconate and alkali hydrogen carbonate, by an alkali-activated binding agent containing sodium gluconate and alkali hydrogen carbonate, and by a method for adjusting the solidification properties in which sodium gluconate and alkali hydrogen carbonate are added to an alkali-activated binding agent.

According to the invention, alkali-activated binding agents shall include both classic geopolymers and mixtures which comprise aluminosilicates or aluminates and silicates and/or calcium (alumino)silicates in combination with an activator and at least also harden by forming three-dimensional crosslinked aluminosilicate polymers, calcium silicate hydrates (C—S—H), calcium aluminate silicate hydrates (C-A-S—H), metal hydroxides (e.g. representatives of the hydrotalcite group) and Ca metal hydroxides (e.g. representatives of the calcium aluminate hydrates). Alkali-activated binding agents with low CaO contents means CaO contents of up to 10 wt % in terms of the total content of reactive CaO in the underlying binding agent system; alkali-activated binding agents with average to high CaO contents are those with >10 wt % CaO, preferably >15 wt % and more CaO.

Preferably, fly ash that can be both calcium rich and silicate rich, granulated blast furnace slag and slag are used as raw materials for the production of alkali-activated binding agents. Depending on the chemical composition of the raw materials, mixtures are used such that a desired content of aluminium oxide, silicon dioxide and other parameters such as the ratio Si/Al, (Si+Al)/Ca etc. are obtained.

The raw materials can be pretreated, for example, in order to remove carbon and other organic components. A thermal or hydrothermal treatment can also take place in which, for example, a conversion from unreactive crystalline phases into amorphous phases takes place.

Fly ashes or dusts from cement production can already be present at the desired level of fineness. If the raw materials are not present at the desired level of fineness, grinding takes place in a known manner. If raw materials are to be mixed, this can often take place advantageously by means of common grinding. When grinding, conventional devices can be used. Depending on the grindability, grinding aids such as triisopropanolamine (TIPA) or triethanolamine (TEA) are preferably used.

The inherently known substances are used as activators. As described above, these are, above all, silicates, hydroxides, carbonates, sulphates and Portland cement or Portland cement clinker and corresponding combinations of the activators previously mentioned. Sodium silicate, potassium silicate, anhydrous sodium metasilicate and sodium metasilicate pentahydrate are preferably used as silicates. Alkaline and alkaline-earth hydroxides and oxides that react to hydroxides when in contact with water are suitable as the hydroxide. Sodium, potassium and calcium hydroxide are particularly preferred. Sodium carbonate is preferably used as the carbonate. Sodium sulphate and potassium sulphate are suitable as sulphates. Portland cement or Portland cement clinker can also be used in the form of waste fractions from the production of Portland cement, such as process meals and dusts.

The type and amount of activator or activators is adjusted to the latent hydraulically and/or pozzolanically active binding agent components/raw materials in an inherently known manner. Usual amounts range from 10 to 20 wt % in terms of the solid content of the binding agent. It should be noted that if using Portland cement (clinker) as an activator, in comparison to Portland composite cement and Portland pozzolan cement, less Portland cement (clinker) is used.

If necessary, dry activators can be advantageously mixed when grinding or can be ground separately. Dissolved activators are expediently added to the mixing water; however they can also be added before or after this.

Depending on the binding agent, the addition of water takes place, above all, for adjusting the flowability and for providing the medium for restructuring the aluminosilicates, aluminates and silicates; with binding agents with a high CaO content, this is also for enabling hydraulic hardening. In the water binding agent value, the binding agent is based on the sum of the aluminosilicates, aluminates, silicates and the solid content of the activators; with water, along with the water connected in the activator, also water optionally introduced for dissolving the activator and/or admixture is taken into account. In general, W/B ranging from 0.2 to 0.5 are useful, in particular 0.3 to 0.45, especially from 0.35 to 0.40.

The fineness of the solid binding agent components according to Blaine typically ranges from 3000 to 5000 cm²/g, in particular at around 4000 cm²/g. Higher fineness leads to an increased reactivity up to a certain limit, but also requires higher grinding energy and more water such that a useful compromise is chosen in an inherently known manner for the respective binding agent and its application.

Along with the binding agent components aluminosilicate, aluminate, silicate and activator(s), the binding agent contains the retarding mixture according to the invention comprising sodium gluconate and alkali hydrogen carbonate for adjusting the open time and thus ensuring a useful processability. Preferably, sodium or potassium hydrogen carbonate are used as the alkali hydrogen carbonate.

The amount preferably ranges from 0.1 to 10 wt % with respect to the binding agent, particularly preferred from 0.5 to 5 wt % and most preferably from 1 to 3 wt %.

The ratio of sodium gluconate to alkali hydrogen carbonate preferably ranges from 9:1 to 1:4, especially at around 3:1 to 1:1.

Retarders based on lignin sulphonates, sulphonated naphthalene, melamine or phenol formaldehyde condensate, or based on acrylic acid acrylamide mixes or polycarboxylate ethers or based on phosphated polycondensates; based on phosphated alkali carboxylic acid and salts thereof, based on (hydroxy)carboxylic acids and carboxylates, in particular citric acid, citrates, tartaric acid, tartrates, borax, boric acid and borates, oxalates, sulphanilic acid, amino carboxylic acids, salicylic acid and acetyl salicylic acid, dialdehydes and mixtures thereof can be used as further components of the retarding mixture.

The retarding mixture according to the invention can be used in the preferred dosing and mixing ratio in both a dissolved and a solid state as components of the binding agent or concrete admixtures. As a binding agent component, the retarding mixture according to the invention is here mixed in to the binding agent as a further component, preferably in a solid state, or, as part of the required grinding processes, is ground together with the binding agent components. As a concrete admixture, the retarding mixture according to the invention can be used in both a dissolved and solid state in the preferred dosing and mixing ratio. In a dissolved state, the retarding mixture is here preferably added to the mixing water. The time point be chosen freely here, but preferably takes place during the mixing process of the binding agent, aggregate and mixing water. The addition preferably takes place in such a manner that a homogeneous distribution of the admixtures in the concrete mixture is ensured; this can take place in individual dosing steps or as a continuous process during the time period of the addition of the mixing water. The retarding mixture according to the invention in dry form is preferably incorporated in after adding the binding agent components.

The retarding mixture according to the invention delays the setting of alkali-activated binding agent systems, in particular of geopolymers that have an average to high CaO content in terms of the solid content of the binding agent, and, in particular in pH ranges above the effectiveness limit of known admixtures. Delaying the setting of the binding agent in concrete and cement mortar leads to a significant lengthening of processing times and thus also of possible transport times. Furthermore, the retarding system is free from chlorides and does not cause any efflorescence. It is suitable as the setting retarder for construction site concrete, transport concrete and pump concrete, for screed and cement mortar and for large monolithic components (e.g. pre-cast uses).

The invention is advantageous, in particular, for binding agents with a high CaO content and significantly alkaline activators. The retarder according to the invention clearly increases the open time without impairing the compressive strength. In some cases, the compressive strength even increases. Particularly advantageous is that the effect increases at higher pH values. Furthermore, a plasticising effect also occurs, by means of which the processability is improved. From an economical point of view, it is noted that the retarder according to the invention is more cost-effective than many other proposals.

The invention is to be illustrated with the aid of the following examples, without, however, being limited to the specifically described embodiments. Unless something else is specified or results in a necessarily different manner from context, percentage values relate to the weight, and, in case of doubt, the total weight of the mixture.

The invention also relates to all combinations of preferred embodiments, unless these are mutually exclusive. The specifications “about” or “approx.” in connection with a numerical figure mean that values that are higher or lower by 10%, values that are higher or lower by 5% and in any case values that are higher or lower by 1% are included.

### EXAMPLE 1

An alkali-activated binding agent comprising 64 wt % fly ash 1, 21 wt % granulated blast furnace slag 1 and 15 wt % activator with regard to the solid content of the binding agent was produced by mixing the aforementioned components. The SiO₂/Na₂O ratio in the activator solution, consisting of a 40% NaOH solution and a commercial water glass by the company PQ (product name: “C0265”) in the mixing ratio of about 1:1.7, here amounted to 1.0. Before bringing together the aforementioned components, fly ash 1 was here ground down to a fineness of 2850 cm²/g, granulated blast furnace slag to a fineness of 4920 cm²/g. The chemical composition of fly ash 1 and granulated blast furnace slag 1 is stated in Table 3. For the binding agent system, a CaO content of 15.1 wt % in terms of the solid content of the binding agent results.

TABLE 3

| | Granulated | Granulated | | | |
|---|---|---|---|---|---|
| | blast | blast | | | |
| | furnace | furnace | | | |
| | slag 1 | slag 2 | Fly ash 1 | Fly ash 2 | Fly ash 3 |
| LOI at | 0.13 | 1.67 | 0.45 | 0.33 | 3.20 |
| 1050° C. | | | | | |
| SiO₂ | 32.91 | 36.65 | 55.55 | 33.60 | 56.73 |
| Al₂O₃ | 13.66 | 11.60 | 23.14 | 17.98 | 21.07 |
| TiO₂ | 0.47 | 0.90 | 1.35 | 1.52 | 0.94 |
| MnO | 0.34 | 0.37 | 0.05 | 0.02 | 0.06 |
| Fe₂O₃ | 1.22 | 0.46 | 5.12 | 5.74 | 7.71 |
| CaO | 41.01 | 38.89 | 10.14 | 27.46 | 4.07 |
| MgO | 5.17 | 7.83 | 1.86 | 6.21 | 1.91 |
| K₂O | 0.35 | 0.66 | 0.95 | 0.38 | 1.78 |
| Na₂O | 0.11 | 0.17 | 0.10 | 2.06 | 0.88 |
| SO₃ | 2.72 | 2.79 | 0.31 | 1.87 | 0.10 |
| P₂O₅ | 0.02 | 0.00 | 0.10 | 1.32 | 0.40 |
| Sum | 98.11 | 101.99 | 99.12 | 98.58 | 98.85 |

Different substances that have been suggested as retarders and the retarder according to the invention were added to the binding agent in a quantity of 4%. Bringing together the components mentioned above in a homogeneous mixture here took place in the following order: 1) fly ash, 2) granulated blast furnace slag, 3) diverse retarders or the retarding mixture according to the invention, 4) activator solution, consisting of sodium hydroxide solution and water glass, 5) mixing water (demin. water). 20 g of binding agent were stirred in by hand at 20° C. and W/B=0.40 in a single-use plastic beaker for two minutes with a spatula, transferred to a small plastic bag that can be sealed to be airtight and then the setting and hardening properties of the paste were observed, tested by bending and finger pressure and assessed according to a number system. The assessment of the solidification takes place according to an empirically developed system of a total of 6 numbers. Numbers 0-3 here describe the properties of the sample before hardening up to a setting that is roughly in the region of the setting end according to DIN 1164. Numbers 4-6 describe the subsequent hardening properties. Number 6 generally points to a mortar compressive strength in the region of about 4 MPa. The numbering of the effects observed obviously includes a subjective, personal component, however, from experience that becomes fairly uniform with increasing practice. The numbering enables the comparison of samples by tabular and graphic depiction. The depiction in curves provides an additional plausibility check. The method is particularly well suited to the relative assessment of solidification processes before and during the setting of binding agents as part of series samples that are changed systematically and in steps. It presents a meaningful precursor to standard tests in which the effect tendency of certain additives or binding agent mixtures, where necessary also by means of a large number of individual attempts, can be seen while using small amounts of material. The time tᵢₙᵢ up to a slight but noticeable stiffening (leathery) was determined. The frequency of the test of a sample was thus determined according to the character of the binding agent, with a rapidly setting and/or rapidly hardening binding agent it proved to be appropriate to check at intervals of about 5 minutes at the start or even more regularly. The results are summarised in Table 4.

TABLE 4

| Retarder | tᵢₙᵢ [min.] |
|---|---|
| without | — |
| ZnO | — |
| NaP₂O₇ | — |
| NaAlO₂ | — |
| C₁₈H₃₅NaO₂ | — |
| NaHCO₃ | 30 |
| C₆H₈O₇ | 40 |
| Na₂HPO₄•2H₂O + | 45 |
| C₆H₁₁NaO₇ + NaHCO₃ | |
| Lignin sulphonate + NaHCO₃ | 55 |
| Na₂HPO₄•2H₂O | 60 |
| Na₂HPO₄•2H₂P + C₆H₁₁NaO₇ | 65 |
| Borax | 65 |
| C₆H₁₁NaO₇ | 90 |
| C₆H₁₁NaO₇ + NaHCO₃ | 120 |

(“—” = not able to be checked, immediate setting)

It is apparent that many substances lengthened the open time, however the mixture according to the invention showed the greatest effect.

### EXAMPLE 2

The binding agent of example 1 and an analogously composed binding agent with fly ash 2 were mixed with 1% of different retarders and, as in example 1, the time until the noticeable stiffening of the paste samples was determined. Furthermore, as described in [00019], mortar prisms were produced and, in addition, the compressive strength was measured after 28 days (stored at 20° C., 100% rel. air humidity). Table 5 summarises the results.

TABLE 5

| | Fly ash 1 | | Fly ash 2 | |
|---|---|---|---|---|
| | average CaO content | | high CaO content | |
| | | 28 days | | 28 days |
| | | compressive | | compressive |
| Retarder | tᵢₙᵢ [min] | strength [MPa] | tᵢₙᵢ [min] | strength [MPa] |
| without | 40 | 45 | — | — |
| NaHCO₃ | 40 | 42 | — | — |
| Na₂HPO₄•2 H₂O | 45 | 33 | 15 | 28 |
| C₆H₁₁NaO₇ | 70 | 45 | 45 | 57 |
| C₆H₁₁NaO₇ + | 95 | 51 | 65 | 62 |
| NaHCO₃ | | | | |
| Lignin sulphonate + | 50 | 48 | 20 | 58 |
| NaHCO₃ | | | | |
| C₆H₁₁NaO₇ + | 55 | 36 | 20 | 35 |
| Na₂HPO₄•2 H₂O | | | | |
| Borax | 50 | 46 | 25 | 55 |

With fly ash 1 that produces a binding agent with a CaO content of about. 15.1 wt % with regard to the solid content of the binding agent, it turned out again that indeed many comparison substances caused a retardation, but not as significantly as according to the invention. The 28 day compressive strength was here impaired or not changed by most substances, however with the retarder according to the invention, it significantly increased.

The binding agent with fly ash 2 had a higher CaO content of about. 26.2 wt % with regard to the solid content of the binding agent and, without retarders, could not be mixed in at all. Adding sodium hydrogen carbonate alone also did not help. With the measurable systems, there was a useful open time and a high compressive strength only for the additive according to the invention.

### EXAMPLE 3

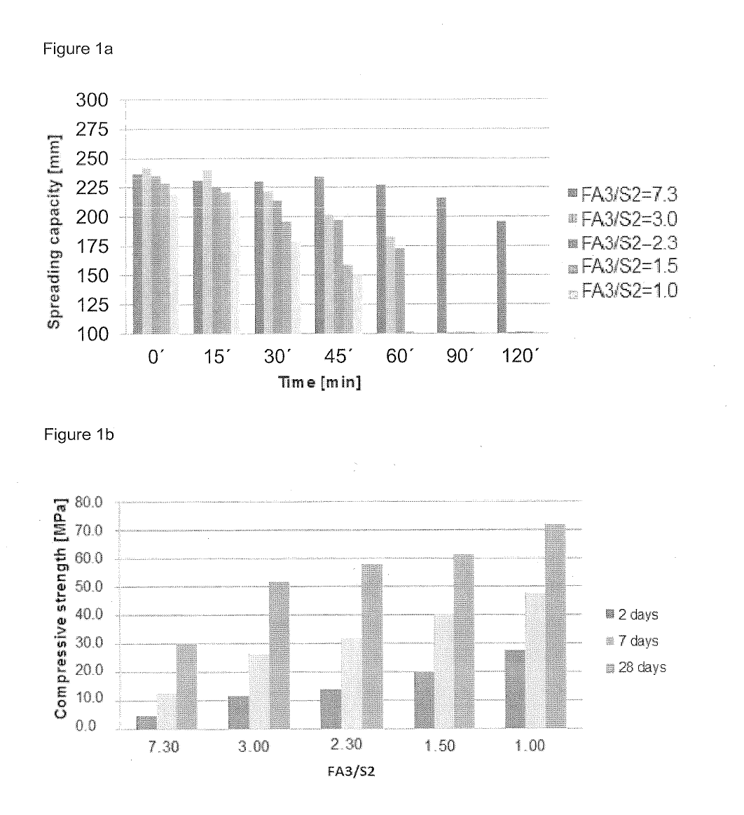

To illustrate the problem underlying the invention, FIG. 1 a shows the spreading capacity measured in mortar samples according to DIN/EN1015-3, and FIG. 1 b shows the compressive strength measured in mortar samples according to DIN/EN 1015-11.

The binding agents used to produce the mortar samples in each case contained fly ash 3 (“FA3”) and granulated blast furnace slag 2 (“S2”) in variable mixing ratios (FA3/S2=7.3−1.0), comprising 85 wt % (total) with regard to the solid content of the binding agent. The CaO content with regard to the solid content of the respective binding agent thus increased from about 7.0 wt % (FA3/S2=7.3) to about 18.0 wt % (FA3/S2=1.0) successively. The chemical composition of fly ash 3 and granulated blast furnace slag 2 is stated in Table 3. The SiO₂/Na₂O ratio in the activator used equally for all binding agents, consisting of 40% NaOH solution and a commercial water glass by the company PQ (product name: “C0265”) in the mixture ratio of about 1:1.7, here amounted to 1.0. The W/B was set to 0.40 for all mortar mixtures. Before bringing together the aforementioned components, fly ash 3 was there ground to a fineness of 4360 cm²/g, granulated blast furnace slag 2 to a fineness of 4450 cm²/g.

It can be easily seen in FIG. 1 a that binding agents with successively increasing CaO content (about 7.0-18.0 wt % with regard to the solid content of the binding agent) respectively increasing granulated slag portion (FA3/S2=7.3−1.0), are worse in processability. In mortar samples, the spreading capacity already significantly decreases after 30-45 min with significantly increased CaO content of >10.0 wt %, accompanied by a clear stiffening of the samples. With an increasing CaO content, the open time reduces to such an extent that a processing is no longer possible. Thus, for such geopolymer binding agents, retarding admixtures are necessary.

FIG. 2 clarifies the ambivalent character of variable CaO contents already described in [00020]. While the binding agent “FA3/S2” described in [00060] with a low CaO content of <10 wt % indeed showed a good processability, though a poor strength development, with the binding agent systems based on fly ash/granulated blast furnace slag, “FA3/S2” with a significantly higher CaO content>10 wt %, a poorer processability in the sense of a very short open time was generally associated with high strengths.

1. Retarding mixture for alakali-activated binding agents, characterised in that it contains a mixture of sodium gluconate and alkali hydrogen carbonate.

2. Retarding mixture according to claim 1, characterised in that the alkali hydrogen carbonate is a sodium hydrogen carbonate, a potassium hydrogen carbonate or a mixture thereof.

3. Retarding mixture according to claim 1, characterised in that the weight ratio of sodium gluconate to alkali hydrogen carbonate ranges from 9:1 to 1:4, preferably from 3:1 to 1:1.

4. Retarding mixture according to claim 1, characterised in that additional retarders based on lignosulphonates, sulphonated naphthalene, melamine or phenol formaldehyde condensates; or based on acrylic acid acrylamide mixtures or polycarboxylate ethers or based on phosphated polycondensates; based on phosphated alkyl carboxylic acids and salts of these; based on (hydroxy)carboxylic acids and carboxylates, in particular citric acid, citrates, tartaric acid, tartrates; borax, boric acid and borates, oxalates; sulfanilic acid; aminocarboxylic acids; salicylic acid and acetylsalicylic acid; dialdehydes and mixtures thereof are contained.

5. Retarding mixture according to claim 4, characterised in that the additional retarders are present in a weight proportion of 10% to 50%, with regard to the retarding mixture.

6. Retarding mixture according to claim 4, characterised in that borax, boric acid and borates are used as additional retarders.

7. Alkali-activated binding agent comprising latent hydraulic and/or pozzolanic component(s) which provide aluminosilicates and/or silicates and aluminosilicates and/or calcium (alumino)silicates, characterised in that a retarding mixture according to claim 1 is contained.

8. Alkali-activated binding agent according to claim 7, characterised in that the latent hydraulic and or pozzolanic component(s) are selected from the group consisting of calcined clay, calcium-rich and/or siliceous fly ash, granulated blast furnace slag, slag and mixtures thereof.

9. Alkali-activated binding agent according to claim 7, characterised in that it contains at least 40% latent hydraulic components and/or calcium-rich, pozzolanic components.

10. Alkali-activated binding agent according to claim 7, characterised in that the latent hydraulic and/or pozzolanic component(s) together have a CaO content of at least 10 wt %.

11. Alkali-activated binding agent according to claim 7, characterised in that from 0.1 to 10 wt % retarding mixture with regard to the binding agent, preferably from 0.5 to 5 wt % and most preferably from 1 to 3 wt % are contained.

12. Alkali-activated binding agent according to claim 7, characterised in that the activated is selected from alkali silicates, hydroxides, alkali carbonates, alkali sulphates, Portland cement, Portland cement clinkers and mixtures of two or more thereof.

13. Alkali-activated binding agent according to claim 7, characterised in that the activator has a weight ratio SiO₂/Na₂O_{equivalent} of at least 1.0, preferably of at least 1.25.

14. Alkali-activated binding agent according to claim 7, characterised in that it contains aluminosilicates, silicates and aluminates and/or calcium (alumino)silicates made of calcined clay, calcium-rich and/or siliceous fly ash, granulated blast furnace slag and/or slag.

15. Alkali-activated binding agent according to claim 7, characterised in that concrete liquefier and/or plasticizer and/or additional retarder are contained, preferably based on lignin sulphonates; sulphonated naphthalene, melamine or phenolformaldehyde condensate; or based on acrylic acid acrylamide mixtures or polycarboxylate ethers or based on phosphated polycondensates; phosphated alkyl carboxylic acid and salts of these; (hydroxy)carboxylic acids and carboxylates, in particular citric acid, citrate, tartaric acid, tartrates; borax, boric acid and borates, oxalates; sulfanilic acid; aminocarboxylic acids; salicylic acid and acetylsalicylic acid; dialdehydes and mixtures thereof.

16. Method for adjusting the strength development of alkali-activated binding agents, characterised in that sodium gluconate and alkali hydrogen carbonate are added to the alkali-activated binding agent as a retarding mixture.

17. Method according to claim 16, characterised in that a sodium hydrogen carbonate, a potassium hydrogen carbonate or a mixture thereof is used as an alkali hydrogen carbonate.

18. Method according to claim 16, characterised in that from 0.1 to 10 wt % of retarders with regard to the binding agent, preferably from 0.5 to 5 wt % and most preferably from 1 to 3 wt %, are used.

19. Method according to claim 16, characterised in that sodium gluconate and alkali hydrogen carbonate are used in a weight ratio sodium gluconate to alkali hydrogen carbonate in the range from 9:1 to 2:8, preferably from about 3:1 to 1:1.
